(19) United States
(12) Patent Application Publication
(10) Pub. No.: US 2008/0232424 A1
(43) Pub. Date: Sep. 25, 2008

(54) Hearth plate including side walls defining a processing volume

(75) Inventors: Brian J. Miller, Mishawaka, IN (US); Akshay Waghray, Granger, IN (US)

Correspondence Address: HONEYWELL INTERNATIONAL INC.;Law Department AB2, P.O.Box 2245, Morristown, NJ, 07962-9806, US

(73) Assignee: HONEYWELL INTERNATIONAL INC.

(21) Appl. No.: 11/727,118

(22) Filed: Mar. 23, 2007

(51) Int. Cl. F27D 1/00

(52) U.S. Cl. 373/72

(57) ABSTRACT

A hearth plate (30) includes a flat rectangular plate (32) having a top surface (34), a bottom surface (36), and a plurality of through openings (38) between the top surface (34) and bottom surface (36), four support walls (40) having top edges connected around the periphery of the bottom surface (36) and bottom edges and a bottom wall (42) connected to the bottom edges of the support walls (40). A preheater structure (46) is mounted in the space (44) defined by the four support walls (40), flat rectangular plate (32) and bottom wall (42), and a rectangular enclosure comprising four interconnected graphite walls (54, 56, 58) is mounted around the peripheral edge of the top surface (34) to define a processing volume for receiving objects (50) to be processed. A graphite lid (72) is removably supported by the rectangular enclosure.

### FIELD OF THE INVENTION

The present invention is directed to an improved hearth plate structure for supporting a product in a furnace, and, more specifically, toward an improved hearth plate that includes a plurality of side walls and a lid defining with the side walls a processing volume for holding products to be processed in a furnace.

### BACKGROUND OF THE INVENTION

Furnaces for carrying out chemical vapor deposition (CVD) and/or chemical vapor infiltration (CVI) are well known and are discussed for example, in U.S. Pat. No. 6,162,298 to Rudolph, the entire contents of which is hereby incorporated by reference. In such furnaces, process gas is introduced into a lower portion of a furnace where it passes through a gas preheating system. There it is heated and distributed before it enters the processing portion of the furnace.

Conventional gas preheating systems generally occupy a relatively large part of the lower portion of a furnace, and this reduces the amount of space in the furnace for holding materials to be processed. If the thickness of such conventional preheaters is reduced, gases may not be heated and mixed to an adequate degree before entering the furnace. The thickness of the preheating system therefore represents a tradeoff between the amount of usable space inside the furnace taken up by the system and the ability of the preheating system to adequately preheat and distribute the gas before it is released into the furnace.

In co-pending U.S. patent application Ser. No. 11/417,033 entitled “Gas Preheater for Chemical Vapor Processing Furnace,” which is assigned to a common assignee, a gas preheater structure for addressing such problems is disclosed. The entire contents of U.S. Ser. No. 11/417,033 is hereby incorporated by reference. The hearth plate discussed in that application may be used in a furnace heated by resistance heating elements. When the products being processed in such a furnace are treated with a hydrocarbon containing gas, the hydrocarbon gas can leave harmful deposits on the resistance heating elements. It is therefore known to provide a flow of shielding gas, such as nitrogen, for protecting the resistance heating elements. This shielding gas, however, tends to dilute the hydrocarbon containing processing gas used to treat the products in the furnace, and this tends to increase the processing time and potentially decrease the quality of a final product. Products being processed in a furnace, such as carbon fiber preforms used to form carbon-carbon brake disks, for example, may be enclosed in cylindrical graphite tubes during processing to protect them from the shielding gas. However, stacking products on a hearth plate and then placing a cylindrical tube over each stack of products it time consuming and labor intensive and reduces the furnace volume available for holding products.

### SUMMARY OF THE INVENTION

This problem and others are addressed by embodiments of the present invention, a first aspect of which comprises a hearth plate that includes a flat plate having a top surface, a bottom surface, and a plurality of through openings between the top surface and bottom surface and at least one support wall connected to the bottom surface and defining with the bottom surface a hearth plate interior volume. A preheater is mounted in the interior volume. A first pair of parallel walls is supported on the top surface and a second pair of parallel walls is supported on the top surface that connect the first pair of parallel walls. A lid is supported by the first and second pairs of parallel walls. The top surface, first and second pairs of parallel walls and the lid define a processing volume for receiving a plurality of objects to be processed in a furnace.

Another aspect of the invention comprises a hearth plate that includes a flat rectangular plate having a top surface, a bottom surface, and a plurality of through openings between the top surface and bottom surface, four support walls having top edges connected around the periphery of the bottom surface and bottom edges and a bottom wall connected to the bottom edges of the support walls. A preheater structure is mounted in the space defined by the four support walls, flat rectangular plate and bottom wall, and a rectangular enclosure comprising four interconnected graphite walls is mounted around the peripheral edge of the top surface. A graphite lid is removably supported by the rectangular enclosure.

A further aspect of the invention comprises a hearth plate removably mounted in a furnace. The furnace includes a floor having at least one opening connected to a source of processing gas, at least one side wall and a top. At least one resistance heating element is mounted on the at least one side wall, and a nozzle connected to a source of shielding gas is arranged to discharge the shielding gas onto the at least one resistance heating element. The hearth plate comprises a bottom plate having at least one opening aligned with the at least one opening in the furnace floor, four support walls having bottom edges mounted on the bottom plate and top edges, a top plate mounted on the top edges of the four support walls and having a top surface having a plurality of openings. A preheater structure is mounted in the space defined by the top plate, bottom plate and four support walls over the at least one opening in the bottom plate. A rectangular enclosure comprising four interconnected graphite walls is mounted around the peripheral edge of the top surface, and a graphite lid removably supported by the rectangular enclosure.

### BRIEF DESCRIPTION OF THE DRAWINGS

These aspects and features of the invention and others will be better understood after a reading of the following detailed description together with the following drawings wherein:

FIG. 1 is a side elevational view, partly in section, schematically illustrating a hearth plate and a resistance furnace according to an embodiment of the present invention;

FIG. 2 is a top plan view of the hearth plate of FIG. 1 with a portion of the hearth plate lid removed;

FIG. 3 is a first side elevational view of the hearth plate of FIG. 1; and

FIG. 4 is a second side elevational view of the hearth plate of FIG. 1.

### DETAILED DESCRIPTION

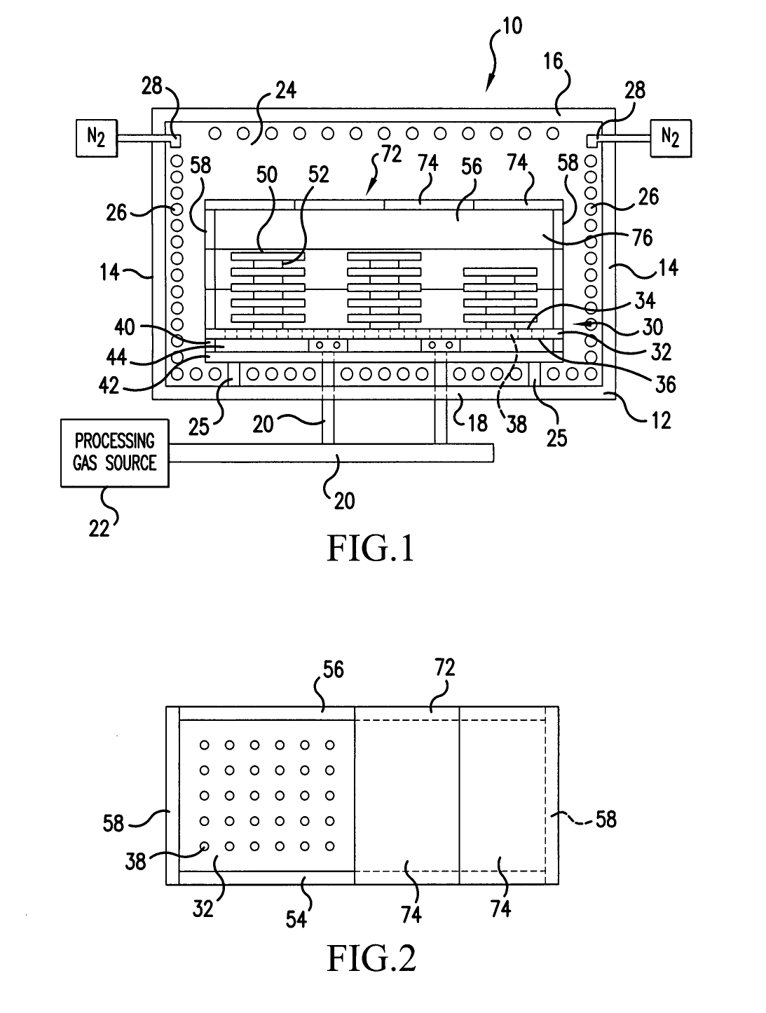

Referring now to the drawings, wherein the showings are for purposes of illustrating embodiments of the invention only and not for the purpose of limiting same, FIG. 1 illustrates a furnace 10 having a floor 12, side walls 14 and a top 16. Floor 12 includes openings 18 to which processing gas pipes 20 are connected providing processing gas from a gas source 22 to the interior 24 of the furnace 10. Resistance heating elements 26 are mounted on the floor 12, side walls 14 and top 16 of furnace 10 and connected to a source of current (not shown) for heating the interior 24 of the furnace 10 in a well known manner. Shielding gas nozzles 28 are mounted near the resistance heating elements 26 and provide a shielding flow of nitrogen or other suitable gas over the resistance heating elements at a positive pressure to substantially prevent processing gases from contacting the heating elements. A conventional venting system (not shown) is provided for removing the nitrogen and processing gas from the furnace.

A hearth plate 30 is removably mounted in the interior 24 of furnace 10 on hearth plate supports 25. Hearth plate 30 includes a support plate 32 having a top surface 34, a bottom surface 36 and a plurality of through openings 38. Side walls 40 depend from bottom surface 36 and space support plate 32 from a bottom plate 42. Bottom plate 42, side walls 40 and top support plate 32 together define a hearth plate interior volume 44. Preheating elements 46 are mounted in the interior volume 44 over openings 47 in bottom plate 42. The openings 47 align with the openings 18 on floor 12 of furnace 10 when the hearth plate 30 is placed into furnace interior 24. Processing gas thus travels from processing gas source 22 through gas pipes 20, through bottom plate 42 and into preheating elements 46. The processing gas heated by the preheating elements 46 passes out of the preheating elements 46, into interior volume 44 and through openings 38 in support plate 32 and into the furnace interior 24.

FIG. 1 further illustrates a plurality of annular products 50 separated by spacers 52 stacked on support plate 32 in furnace 10.

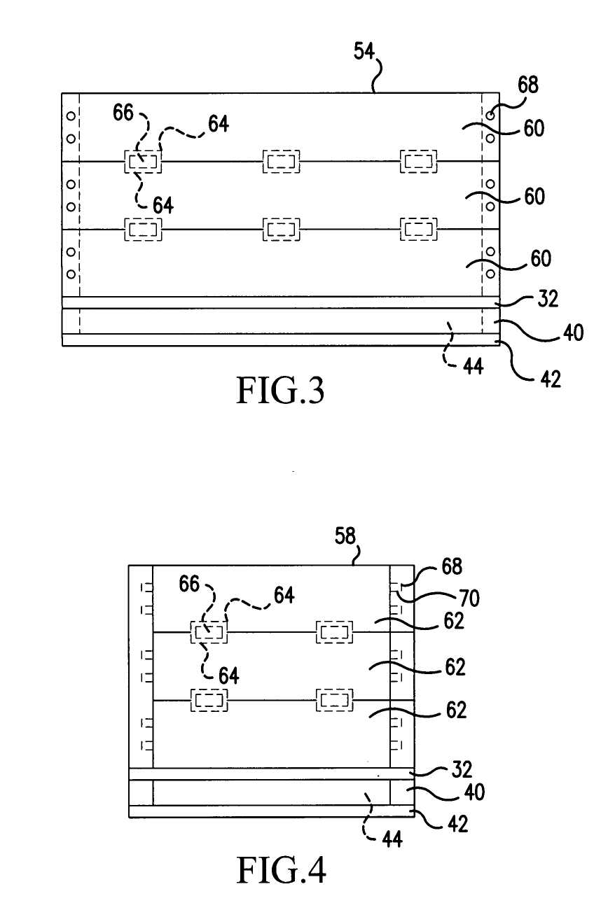

Four interconnected walls are mounted on top surface 34 of support plate 32 and form a rectangular enclosure thereon. These walls include a front wall 54, a rear wall 56 parallel to front wall 54, and first and second side walls 58 connecting the front wall 54 and the rear wall 56. The front, rear and side walls are formed from graphite, and as illustrated in FIG. 3, front wall 54 includes three course 60 of graphite while the side walls 58 are also formed from three courses of graphite 62. Pockets 64 are provided in the side edges of some of the individual courses 60, 62 which align with pockets 64 on adjacent courses 60, 62 and which allow adjacent courses to be interconnected with biscuits 66. Side walls 58 include projecting pins 68 received in openings 70 in the front and rear walls 54, 56 to connect the aforementioned walls to one another and form an rectangular enclosure. A lid 72 comprising a plurality of individual lid elements 74 rests on the top courses of the front, rear and side walls and defines with these walls a processing volume 76 for receiving products to be processed.

In use, hearth plate 30 is placed on a support outside furnace 10 and lid 72 is removed to allow access to the processing volume 76. Stacks of product 50 separated by spacers 52 are formed on support plate 32, and lid 72 is replaced on the rectangular enclosure. The entire hearth plate 30 with products supported thereby is then placed onto floor 12 of furnace 10 with openings 47 in bottom plate 42 aligned with the openings 18 on floor 12 to allow processing gas to enter interior volume 44. The furnace door (not shown) is closed and the resistance heating elements 26 are activated to heat the interior of the furnace. Heating the front, rear and side graphite walls helps convey an even heat to the processing volume 76. When a desired temperature is achieved, a shielding gas such as nitrogen starts to flow from nozzles 28 and processing gas is provided to hearth plate interior volume 44. The processing gas is heated by contact with preheating elements 46 and the other portions of the hearth plate 30 and emerges through openings 38 into support plate 32 into processing volume 76 where it contacts products 50 and is thereafter vented from processing volume 44 by one or more vents (not shown). In addition to providing for more event heating, the rectangular enclosure formed by walls 54, 56 and 58 substantially protects products 50 from the nitrogen or other shielding gas. In addition, because the volume into which the processing gas is emitted, namely processing volume 76, is smaller than furnace interior 24, less processing gas can be used to process a given number of products than might be required if a hearth plate without the aforementioned rectangular enclosure were used.

The present invention has been described herein in terms of a preferred embodiment. Modifications and additions to this embodiment will become apparent to those skilled in the relevant arts upon a reading of the foregoing disclosure. It is intended that all such modifications be included within the scope of the present invention to the extent they fall within the scope of the several claims appended hereto.

What is claimed is:

1. A hearth plate comprising:
a flat plate having a top surface, a bottom surface, and a plurality of through openings between the top surface and bottom surface;
at least one support wall connected to said bottom surface and defining with said bottom surface a hearth plate interior volume;
a preheater mounted in said interior volume;
a first pair of parallel walls supported on said top surface;
a second pair of parallel walls supported on said top surface and connecting said first pair of parallel walls; and
a lid supported by said first and second pairs of parallel walls;
wherein said top surface, first and second pairs of parallel walls and said lid define a processing volume for receiving a plurality of objects to be processed in a furnace.

2. The hearth plate of claim 1 further including a bottom plate attached to said at least one support wall and defining with said at least one support wall and said flat plate said hearth plate interior volume.

3. The hearth plate of claim 1 wherein said first and second pairs of parallel walls are formed from graphite.

4. The hearth plate of claim 3 wherein said first pair of parallel walls are formed from at least two courses of graphite.

5. The hearth plate of claim 1 wherein said first and second pairs of parallel walls are connected to the top surface of said flat plate.

6. The hearth plate of claim 1 wherein said lid comprises a plurality of discrete lid elements.

7. A hearth plate comprising:
a flat rectangular plate having a top surface, a bottom surface, and a plurality of through openings between the top surface and bottom surface;
four support walls having top edges connected around the periphery of the bottom surface and bottom edges;
a bottom wall connected to the bottom edges of the support walls;
a preheater structure mounted in the space defined by the four support walls, flat rectangular plate and bottom wall;
a rectangular enclosure comprising four interconnected graphite walls mounted around the peripheral edge of said top surface; and
a graphite lid removably supported by said rectangular enclosure.

8. The hearth plate of claim 7 wherein said bottom wall includes at least one through opening aligned with said preheater structure for allowing gas to pass through said bottom wall and into said preheater structure.

9. The hearth plate of claim 7 wherein said interconnected graphite walls are formed from at least two courses of graphite.

10. The hearth plate of claim 7 wherein said interconnected graphite walls are connected to the top surface of said flat plate.

11. The hearth plate of claim 7 wherein said lid comprises a plurality of discrete lid elements.

12. A hearth plate removably mounted in a furnace,
the furnace comprising:
a floor having at least one opening connected to a source of processing gas;
at least one side wall;
a top;
at least one resistance heating element mounted on said at least one side wall; and
a nozzle connected to a source of shielding gas and arranged to discharge the shielding gas onto the at least one resistance heating element;
the hearth plate comprising:
a bottom plate having at least one opening aligned with the at least one opening in the furnace floor;
four support walls having bottom edges mounted on said bottom plate and top edges;
a top plate mounted on the top edges of the four support walls and having a top surface having a plurality of openings;
a preheater structure mounted in the space defined by the top plate, bottom plate and four support walls over the at least one opening in the bottom plate;
a rectangular enclosure comprising four interconnected graphite walls mounted around the peripheral edge of said top surface; and
a graphite lid removably supported by said rectangular enclosure.

13. The hearth plate of claim 12 wherein said interconnected graphite walls are formed from at least two courses of graphite.

14. The hearth plate of claim 12 wherein said interconnected graphite walls are connected to the top surface of said top plate.

15. The hearth plate of claim 12 wherein said graphite lid comprises a plurality of discrete lid elements.
